(19) United States
(12) Patent Application Publication
(10) Pub. No.: US 2011/0255392 A1
(43) Pub. Date: Oct. 20, 2011

(54) OPTICAL PICKUP DEVICE

(75) Inventors: Yasuyuki Kano, Anpachi-gun (JP); Tetsuhisa Hosokawa, Anpachi-gun (JP)

(73) Assignees: SANYO Optec Design Co., Ltd., Bunkyo-ku (JP); SANYO Electric Co., Ltd., Moriguchi-shi (JP)

(21) Appl. No.: 13/086,733

(22) Filed: Apr. 14, 2011

(30) Foreign Application Priority Data
Apr. 15, 2010 (JP) 2010-093871

(51) Int. Cl. G11B 7/135

(52) U.S. Cl. 369/112.24; G9B/7.128

(57) ABSTRACT

A semiconductor laser emits infrared laser light for CD and red laser light for DVD. A collimator lens and a CD/DVD objective lens have optical axes thereof aligned with an optical axis of the infrared laser light. The CD/DVD objective lens is mounted on a holder to be inclined in such a direction as to suppress inherent coma aberration of the CD/DVD objective lens, and to suppress astigmatism generated in the red laser light from a state in parallel to a reference plane of the holder.

This application claims priority under 35 U.S.C. Section 119 of Japanese Patent Application No. 2010-093871 filed Apr. 15, 2010, entitled “OPTICAL PICKUP DEVICE”. The disclosure of the above application is incorporated herein by reference.

### BACKGROUND OF THE INVENTION

1. Field of the Invention

The present invention relates to an optical pickup device, and more particularly to an optical pickup device for allowing laser light of two wavelengths to enter into an objective lens.

2. Disclosure of Related Art

Currently, there have been commercialized various kinds of optical discs, such as Compact Discs (CDs) and Digital Versatile Discs (DVDs). As various kinds of optical discs have been manufactured, there have been developed optical pickup devices compatible with these various kinds of optical discs.

In such an optical pickup device, laser light of different wavelengths is each irradiated onto corresponding optical discs. In this case, a so-called multi-emission semiconductor laser configured to house two laser elements in a CAN may be used. Each laser element emits laser light of each wavelength in a state that the optical axes of the laser elements are displaced from each other. The layout of the optical system of the optical pickup device is designed, for example, by referring to the optical axis of one of the laser light. In this case, the other of the laser light enters into a collimator lens or an objective lens in a state that the optical axis thereof is displaced.

The optical pickup device has a problem of coma aberration. Coma aberration is increased, as the thickness of a protection layer of a disc is increased. Further, coma aberration is increased, as the numerical aperture of an objective lens is increased. Furthermore, coma aberration is increased, as the wavelength of laser light is shortened. In addition to the above, coma aberration is generated resulting from shape error of an objective lens. In the case where an objective lens is made of a resin material, the magnitude and the direction of coma aberration resulting from shape error differ in each of molding rods.

Coma aberration inherent to an objective lens can be suppressed by disposing the objective lens with an inclination and generating comma aberration in a direction opposite to the direction of the generated coma aberration. However, if the objective lens is inclined as described above, the optical axis of laser light is also inclined with respect to the optical axis of the objective lens, and astigmatism is generated. In particular, as described above, in the case where laser light of two wavelengths enters into the objective lens, laser light entering into the collimator lens with an optical axis displacement enters into the objective lens in an oblique direction. As a result, if the objective lens is inclined in such a direction as to cancel the coma aberration, the astigmatism generated in the laser light to enter from an oblique direction may be further increased.

### SUMMARY OF THE INVENTION

A main aspect of the invention is to provide an optical pickup device compatible with different kinds of optical discs. The optical pickup device of this aspect includes a first laser light source having a first laser element which emits first laser light and a second laser element which emits second laser light of a wavelength different from a wavelength of the first laser light, the first laser element and the second laser element being housed in a CAN with emission directions thereof being the same as each other; a collimator lens into which the first laser light and the second laser light enter; a first objective lens on which the first laser light and the second laser light transmitted through the collimator lens enter; and a holder which holds the first objective lens thereon. In this arrangement, the collimator lens and the first objective lens are disposed at such positions that optical axes thereof are aligned with an optical axis of the first laser light. Further, the first objective lens is mounted on the holder to be inclined in such a direction as to suppress coma aberration of the first objective lens and to suppress astigmatism generated in the second laser light with respect to a state in parallel to a reference plane of the holder.

It should be noted that “the reference plane” is a plane perpendicular to the optical axis of the first laser light, in the case where the holder is in a neutral position, in other words, the holder is positioned at such a position that the first laser light is focused on a corresponding optical disc. “The reference plane” may be an actual surface of the holder, or an imaginary plane defined for the holder. In actual designing, a plane along which the optical pickup device is guided in a thread direction by a guide shaft of an optical disc device may be defined as “the reference plane”.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an arrangement of an optical pickup device embodying the invention.

FIGS. 2A and 2B are diagrams showing an arrangement of a semiconductor laser in the embodiment.

FIGS. 3A and 3B are diagrams for describing an inclination adjusting mechanism of an objective lens in the embodiment.

FIGS. 4A and 4B are diagrams for describing a manner as to how an objective lens is inclined in the embodiment.

FIGS. 5A and 5B are diagrams schematically showing that inherent coma aberration is suppressed in the embodiment.

FIG. 6 is a diagram showing a relation between inclination angle of an objective lens and astigmatism in the embodiment.

FIGS. 7A through 7D are diagrams showing a modification example as to how an objective lens is inclined in the embodiment.

FIGS. 8A through 8D are diagrams showing a relation between inclination direction of an objective lens and incident direction of light from DVD on the objective lens in the embodiment.

FIGS. 9A through 9D are diagrams showing a relation between inclination direction of an objective lens and incident direction of light from DVD on the objective lens in the embodiment.

FIGS. 10A and 10B are diagrams showing a modification example of the arrangement of the optical pickup device in the embodiment.

FIGS. 11A and 11B are diagrams showing another modification example of the arrangement of the optical pickup device in the embodiment.

FIG. 12 is a diagram showing an advantage provided by the embodiment.

FIGS. 13A and 13B are diagrams showing another advantage provided by the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is an example, wherein the present invention is applied to an optical pickup device compatible with Blu-ray Disc (BD), Compact Disc (CD), and Digital Versatile Disc (DVD).

In the embodiment, a semiconductor laser 121 corresponds to a first laser light source in the claims. A CD/DVD objective lens 127 corresponds to a first objective lens in the claims. An objective lens actuator 132 corresponds to an actuator in the claims. A semiconductor laser 101 corresponds to a second laser light source in the claims. A BD objective lens 108 corresponds to a second objective lens in the claims. The description regarding the correspondence between the claims and the embodiment is merely an example, and the claims are not limited by the description of the embodiment.

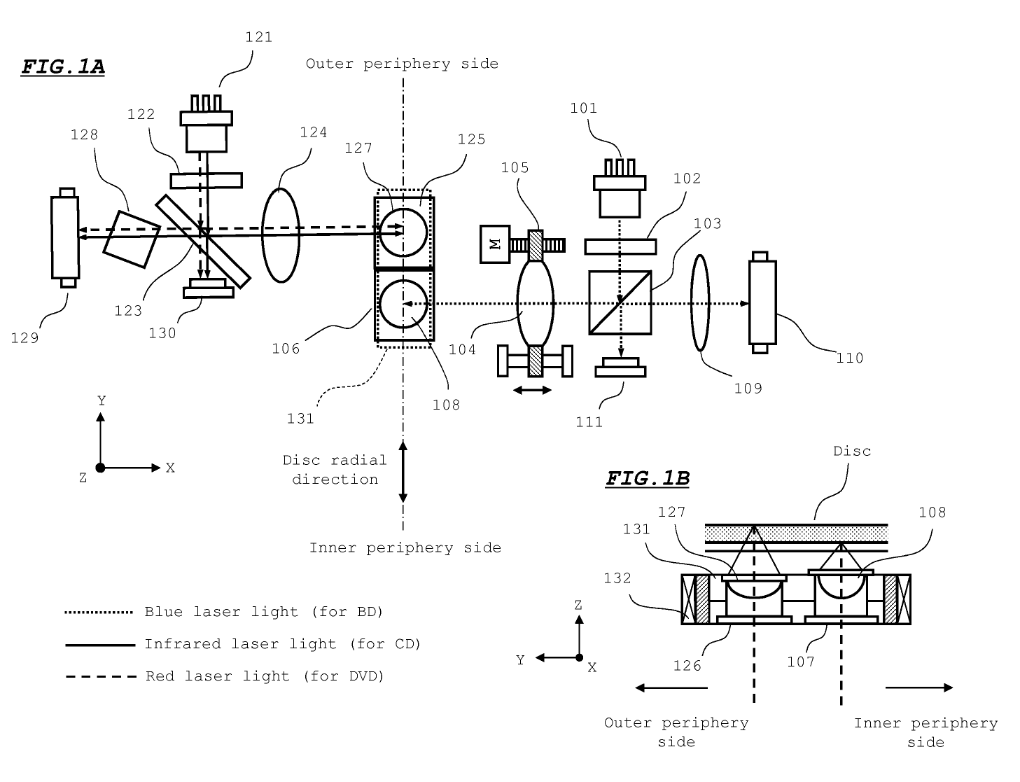

FIGS. 1A and 1B show an optical system of the optical pickup device embodying the invention. FIG. 1A is a top plan view of the optical system, and FIG. 1B is an internal perspective view of peripheral parts of an objective lens actuator when viewed from a side thereof. The optical system is divided into a BD optical system and a CD/DVD optical system.

The BD optical system is constituted of a semiconductor laser 101, a diffraction grating 102, a polarized beam splitter 103, a collimator lens 104, a lens actuator 105, a rise-up mirror 106, a quarter wavelength plate 107, a BD objective lens 108, an anamorphic lens 109, a photodetector 110, and an Front Monitor Diode (FMD) 111.

The semiconductor laser 101 outputs blue laser light of a wavelength of or about 400 nm. The diffraction grating 102 divides the laser light emitted from the semiconductor laser 101 into a main beam and two sub beams. The polarized beam splitter 103 reflects and transmits the laser light entering from the side of the diffraction grating 102. The semiconductor laser 101 is disposed at such a position that the polarization direction of emergent laser light is slightly displaced from a direction of S-polarized light with respect to the polarized beam splitter 103. With this arrangement, for instance, 95% of laser light transmitted through the diffraction grating 102 is reflected on the polarized beam splitter 103, and 5% thereof is transmitted through the polarized beam splitter 103.

The collimator lens 104 converts the laser light reflected on the polarized beam splitter 103 into parallel light. The lens actuator 105 drives the collimator lens 104 in the optical axis direction of laser light. The collimator lens 104 and the lens actuator 105 function as aberration correcting means.

The rise-up mirror 106 reflects the laser light entered through the collimator lens 104 in a direction (Z-axis direction in FIGS. 1A and 1B) toward the BD objective lens 108. The quarter wavelength plate 107 converts the laser light reflected on the rise-up mirror 106 into circularly polarized light, and converts the light reflected on the disc into linearly polarized light in a direction orthogonal to the polarization direction of light toward the disc. With this arrangement, a primary part of the laser light reflected on the disc is guided to the photodetector 110 through the polarized beam splitter 103.

The BD objective lens 108 is designed to properly converge laser light of a blue wavelength on a signal surface of BD. Specifically, the BD objective lens 108 is designed so that laser light of a blue wavelength is properly converged on a signal surface via a substrate of 0.1 mm in thickness.

The anamorphic lens 109 converges the laser light reflected on the disc on the photodetector 110. In converging, astigmatism is given to the laser light. The photodetector 110 has a sensor layout for deriving a reproduction RF signal, a focus error signal, and a tracking error signal based on an intensity distribution of the received laser light. In this embodiment, an astigmatism method is adopted as a method for generating a focus error signal, and a Differential Push Pull (DPP) method is adopted as a method for generating a tracking error signal. The photodetector 110 has a sensor layout for deriving a focus error signal and a tracking error signal in accordance with these methods.

The FMD 111 receives the laser light transmitted through the polarized beam splitter 103, and outputs a signal in accordance with the received light amount. The signal from the FMD 111 is used to control an output of the semiconductor laser 101.

The CD/DVD optical system is constituted of a semiconductor laser 121, a diffraction grating 122, a parallel flat plate 123, a collimator lens 124, a rise-up mirror 125, a quarter wavelength plate 126, a CD/DVD objective lens 127, a correcting plate 128, a photodetector 129, and an Front Monitor Diode (FMD) 130.

The semiconductor laser 121 is provided with laser elements for outputting infrared laser light of a wavelength of about 780 nm and red laser light of a wavelength of about 650 nm within a CAN.

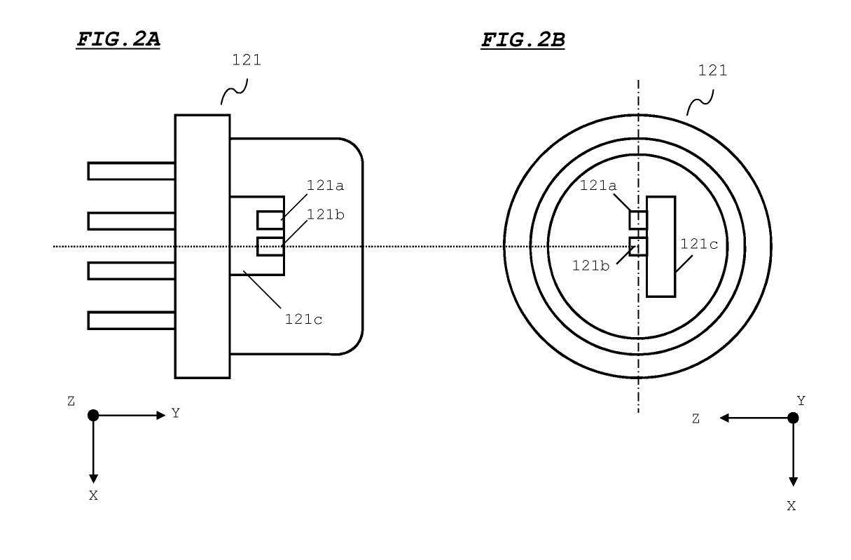

FIGS. 2A and 2B show an arrangement of the semiconductor laser 121. FIG. 2A is a perspective side view, and FIG. 2B is a perspective top plan view when viewed from the side of an emission port. In FIGS. 2A and 2B, the reference numerals 121a and 121b denote the laser elements. The laser element 121a emits red laser light of a wavelength of or about 650 nm, and the laser element 121b emits infrared laser light of a wavelength of or about 780 nm. As shown in FIGS. 2A and 2B, the laser elements 121a and 121b are mounted on a base member 121c with a certain interval so that the laser elements 121a and 121b are linearly aligned when viewed from the side of the emission port.

Referring back to FIG. 1A, the diffraction grating 122 divides the laser light emitted from the semiconductor laser 121 into a main beam and two sub beams. Similarly to the polarized beam splitter 103, the parallel flat plate 123 reflects and transmits the laser light entered from the side of the diffraction grating 122. The parallel flat plate 123 is formed with a polarization film on an incident surface of laser light thereof. The semiconductor laser 121 is disposed at such a position that the polarization direction of emergent laser light is slightly displaced from a direction of S-polarized light with respect to the polarization film of the parallel flat plate 123. With this arrangement, for instance, 95% of laser light transmitted through the diffraction grating 122 is reflected on the parallel flat plate 123 (polarization film), and 5% thereof is transmitted through the parallel flat plate 123 (polarization film).

The collimator lens 124 converts the laser light reflected on the parallel flat plate 123 into parallel light.

The rise-up mirror 125 reflects the incident laser light through the collimator lens 124 in a direction (Z-axis direction in FIGS. 1A and 1B) toward the CD/DVD objective lens 127. The quarter wavelength plate 126 converts the laser light reflected on the rise-up mirror 125 into circularly polarized light, and converts the light reflected on the disc into linearly polarized light in a direction orthogonal to the polarization direction of light toward the disc. With this arrangement, a primary part of the laser light reflected on the disc is guided to the photodetector 129 through the parallel flat plate 123.

The CD/DVD objective lens 127 is designed to properly converge laser light of an infrared wavelength and laser light of a red wavelength on signal surfaces of CD and DVD. Specifically, the CD/DVD objective lens 127 is designed to properly converge laser light of an infrared wavelength on a signal surface via a substrate of 1.2 mm in thickness, and to properly converge laser light of a red wavelength on a signal surface via a substrate of 0.6 mm in thickness.

The correcting plate 128 adjusts the direction of astigmatism generated in the laser light reflected on the disc and transmitted through the parallel flat plate 123. Astigmatism is given by allowing the laser light reflected on the disc to transmit through the parallel flat plate 123. The correcting plate 128 is disposed to be inclined with respect to the optical axis of laser light so that the direction of the given astigmatism has an angle of 45 degrees with respect to the direction of a track image from the disc. Specifically, the astigmatism given by the parallel flat plate 123 and the astigmatism given by the correcting plate 128 are combined, and the direction of the combined astigmatism has an angle of 45 degrees with respect to the direction of a track image from the disc, on the light receiving surface of the photodetector 129.

The photodetector 129 has a sensor layout for deriving a reproduction RF signal, a focus error signal, and a tracking error signal based on an intensity distribution of the received laser light. In this embodiment, as described above, an astigmatism method is adopted as a method for generating a focus error signal, and a Differential Push Pull (DPP) method is adopted as a method for generating a tracking error signal. The photodetector 129 has a sensor layout for deriving a focus error signal and a tracking error signal in accordance with these methods.

The FMD 130 receives the laser light entered from the side of the diffraction grating 122 and transmitted through the parallel flat plate 123, and outputs a signal in accordance with the received light amount. The signal from the FMD 130 is used to control an output of the semiconductor laser 121.

In this embodiment, the layout of the CD/DVD optical system is designed by referring to infrared laser light for CD. Accordingly, the optical axes of the collimator lens 124 and the CD/DVD objective lens 127 are aligned with the optical axis of infrared laser light for CD, and red laser light for DVD enters on the collimator lens 124 and on the CD/DVD objective lens 127 with an optical axis displacement. The displacement amount between the optical axis of red laser light for DVD, and the optical axes of the collimator lens 124 and the CD/DVD objective lens 127 corresponds to the interval between the laser elements 121a and 121b shown in FIGS. 2A and 2B.

Infrared laser light and red laser light are emitted from the semiconductor laser 121 in minus Y-axis direction with a predetermined optical axis displacement. Thereafter, the infrared laser light and the red laser light are reflected on the parallel flat plate 123, and propagate in plus X-axis direction. Since the optical axis of infrared laser light is aligned with the optical axis of the collimator lens 124, the infrared laser light is transmitted through the collimator lens 124 and propagates in plus X-axis direction. On the other hand, since the optical axis of red laser light is displaced from the optical axis of the collimator lens 124, the red laser light propagates in a direction inclined toward minus Y-axis direction from plus X-axis direction, after having been transmitted through the collimator lens 124. Thereafter, the infrared laser light and the red laser light are reflected on the rise-up mirror 125. The reflected infrared laser light propagates in plus Z-axis direction, and enters on the CD/DVD objective lens 127. On the other hand, the red laser light propagates in a direction inclined toward minus Y-axis direction from plus Z-axis direction, and enters on the CD/DVD objective lens 127.

The BD objective lens 108 and the CD/DVD objective lens 127, and the quarter wavelength plates 107 and 126 are mounted on a holder 131. The holder 131 is driven in focus direction and in tracking direction by an objective lens actuator 132. Accordingly, the BD objective lens 108 and the CD/DVD objective lens 127, and the quarter wavelength plates 107 and 126 are integrally driven in accordance with driving of the holder 131. The objective lens actuator 132 is constituted of coils and magnetic circuits, and the coils are attached to the holder 131. The holder 131 may also be driven in tilt direction.

The BD objective lens 108 and the CD/DVD objective lens 127 are disposed to be aligned in radial direction (Y-axis direction) of the disc when the optical pickup device is mounted on an optical disc device. In mounting, the BD objective lens 108 whose lens diameter is smaller than the lens diameter of the CD/DVD objective lens 127 is disposed on the disc inner periphery side than the CD/DVD objective lens 127. Further, the BD objective lens 108 and the CD/DVD objective lens 127 are disposed to be inclined with respect to a reference plane (to be described later) of the holder 131.

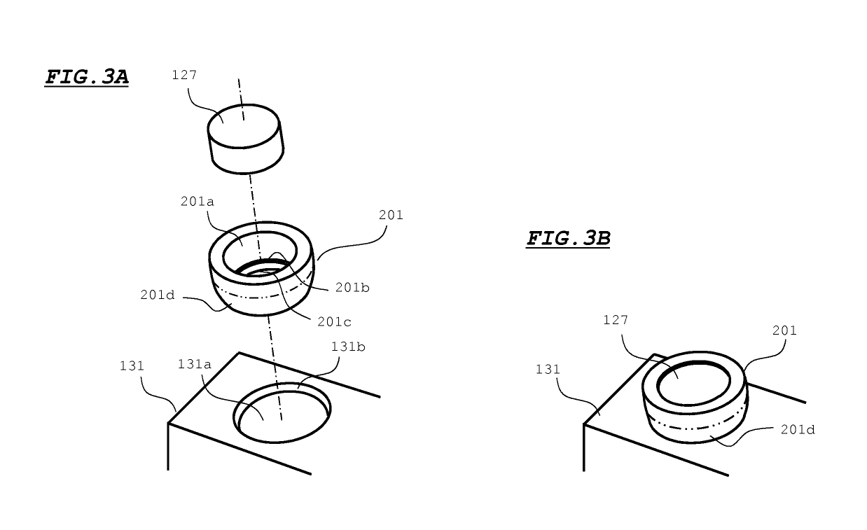

FIGS. 3A and 3B are diagrams for describing an inclination adjusting mechanism for the BD objective lens 108 and for the CD/DVD objective lens 127. In FIGS. 3A and 3B, only the inclination adjusting mechanism for the CD/DVD objective lens 127 is shown, but the inclination adjusting mechanism for the BD objective lens 108 has the same construction as the inclination adjusting mechanism for the CD/DVD objective lens 127.

Referring to FIG. 3A, the CD/DVD objective lens 127 is mounted on the holder 131 in a state that the CD/DVD objective lens 127 is mounted on a lens holder 201.

The lens holder 201 is axially symmetrical and has a top-like shape. The lens holder 201 is formed with a lens housing portion 201a in which the CD/DVD objective lens 127 is allowed to be housed from above. The lens housing portion 201a has a cylindrical inner surface, and the diameter thereof is set slightly larger than the diameter of the CD/DVD objective lens 127.

An annular step portion 201b is formed on a lower portion of the lens housing portion 201a. A circular opening 201c continuing from the step portion 201b is formed in a bottom surface of the lens holder 201 and is exposed to the outside. The inner diameter of the step portion 201b is set smaller than the diameter of the CD/DVD objective lens 127. The distance from the top surface of the lens holder 201 to the step portion 201b is set slightly larger than the thickness of the CD/DVD objective lens 127 in the optical axis direction thereof.

A bottom portion (a portion lower than the two-dotted chain line in FIG. 3A) of the lens holder 201 is formed into a spherical surface 201d. As will be described later, the spherical surface 201d is plane-contacted with a receiving portion 131b formed in the top surface of the holder 131.

The holder 131 is formed with an opening 131a vertically extending therethrough. Further, the spherical-shaped receiving portion 131b in plane-contact with the spherical surface 201d of the holder 201 is formed in the top surface of the holder 131.

First of all, in mounting the CD/DVD objective lens 127, the CD/DVD objective lens 127 is housed in the lens housing portion 201a of the lens holder 201. After the CD/DVD objective lens 127 is housed in the lens housing portion 201a to such a degree that a lower end of the CD/DVD objective lens 127 is abutted against the step portion 201b of the lens housing portion 201a, the CD/DVD objective lens 127 is adhesively fixed to the lens holder 201. Thus, the CD/DVD objective lens 127 is attached to the lens holder 201.

Thereafter, as shown in FIG. 3B, the spherical surface 201d of the lens holder 201 is placed in the receiving portion 131b of the holder 131. In this state, the spherical surface 201d of the lens holder 201 is swingable in any direction by sliding contact with the receiving portion 131b.

Thereafter, as will be described later, the CD/DVD objective lens 127 is swingingly moved in such a direction as to cancel the coma aberration of the CD/DVD objective lens 127, and a peripheral surface of the lens holder 201 and the top surface of the holder 131 are fixed to each other by an adhesive agent at an intended inclined position. Thus, the CD/DVD objective lens 127 is fixed at such a position that the coma aberration of the CD/DVD objective lens 127 is cancelled. As will be described later, the direction of inclining the CD/DVD objective lens 127 is set to be aligned with a direction of suppressing astigmatism generated in red laser light for DVD.

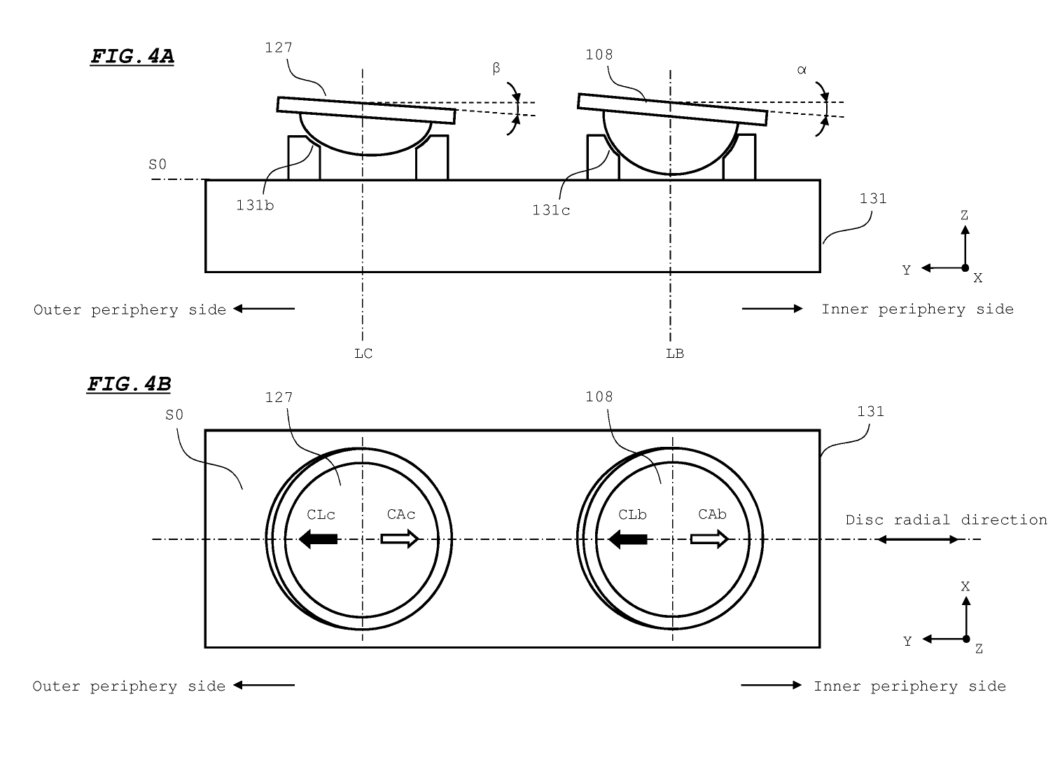

FIGS. 4A and 4B are schematic diagrams for describing how the BD objective lens 108 and the CD/DVD objective lens 127 are inclined. FIG. 4A is a side view of the holder 131 when viewed from X-axis direction in FIG. 1, and FIG. 4B is a top plan view of the holder 131 when viewed from Z-axis direction in FIG. 1.

To simplify the description, in FIGS. 4A and 4B, the BD objective lens 108 and the CD/DVD objective lens 127 are placed on a base block. Actually, however, as shown in FIGS. 3A and 3B, each of the objective lenses is mounted on a lens holder, and is received in a corresponding receiving portion (spherical surface) of the lens holder. The reference numeral 131b denotes a receiving portion for receiving a bottom surface (spherical surface 201d) of the lens holder 201 which holds the CD/DVD objective lens 127, and the reference numeral 131c denotes a receiving portion for receiving a bottom surface (spherical surface) of a lens holder which holds the BD objective lens 108.

FIGS. 4A and 4B show a state that the holder 131 is set to a neutral position. Here, “the neutral position” is a position of the holder 131 when infrared laser light or blue laser light is individually focused on a recording layer of CD or BD. In this embodiment, when the holder 131 is set to the neutral position, the top surface of the holder 131 is perpendicular to the optical axis LC of infrared laser light or the optical axis LB of blue laser light. Inclinations of the BD objective lens 108 and the CD/DVD objective lens 127 are adjusted by aligning the top surface of the holder 131 when the holder 131 is set to the neutral position with a reference plane S0. “The reference plane” may be an actual surface of the holder 131, or an imaginary plane defined for the holder 131. In actual designing, a plane along which the optical pickup device is guided in a thread direction by a guide shaft of an optical disc device may be defined as “the reference plane”.

Referring to FIGS. 4A and 4B, the BD objective lens 108 and the CD/DVD objective lens 127 have coma aberration (hereinafter, the coma aberration is called as “inherent coma aberration”) inherent to laser light of each wavelength, resulting from shape error and the like. Here, the magnitude of inherent coma aberration changes depending on the wavelength /of laser light to enter into the objective lens. On the other hand, the direction of inherent coma aberration does not change, even if the wavelength of laser light to enter into the objective lens changes.

In this embodiment, the BD objective lens 108 and the CD/DVD objective lens 127 are disposed at such positions that both of the directions of inherent coma aberration CLb of blue laser light enters into the BD objective lens 108, and inherent coma aberration CLc of infrared laser light enters into the CD/DVD objective lens 127 are aligned in parallel to the disc radial direction, and are directed in the direction (plus Y-axis direction) toward the disc outer periphery. Then, the BD objective lens 108 and the CD/DVD objective lens 127 are respectively mounted on the holder 131 to be inclined with angles α and β in such a direction that the disc outer periphery sides of the BD objective lens 108 and the CD/DVD objective lens 127 are raised in parallel to Y-Z plane from a state in parallel to the reference plane S0.

When the BD objective lens 108 and the CD/DVD objective lens 127 are inclined as described above, coma aberration (hereinafter, this coma aberration is called as “correction coma aberration”) in the direction opposite to the directions of the inherent coma aberrations CLb and CLc are generated. Here, the magnitude of correction coma aberration changes depending on the wavelength of laser light to enter into the objective lens, and also changes depending on the inclination angle of the objective lens. The direction of correction coma aberration depends on the inclination direction of the objective lens.

The inclination angle α of the BD objective lens 108 is set to an angle corresponding to a magnitude with which correction coma aberration CAb generated in blue laser light resulting from the inclination of the BD objective lens 108 cancels the inherent coma aberration CLb. Further, the inclination angle β of the CD/DVD objective lens 127 is set to an angle corresponding to a magnitude with which correction coma aberration CAc generated in infrared laser light resulting from the inclination of the CD/DVD objective lens 127 cancels the inherent coma aberration CLc. The angle adjustments are performed based on the main beam out of the three beams divided by the diffraction gratings 102 and 122.

Mounting the BD objective lens 108 and the CD/DVD objective lens 127 on the holder 131 as described above suppresses the inherent coma aberrations CLb and CLc with respect to blue laser light and infrared laser light. Thus, it is possible to irradiate blue laser light and infrared laser light on recording layers of BD and CD in a satisfactory beam state.

Setting the inclination angle β of the CD/DVD objective lens 127 by referring to infrared laser light for CD as described above also smoothly suppresses inherent coma aberration with respect to red laser light for DVD as follows.

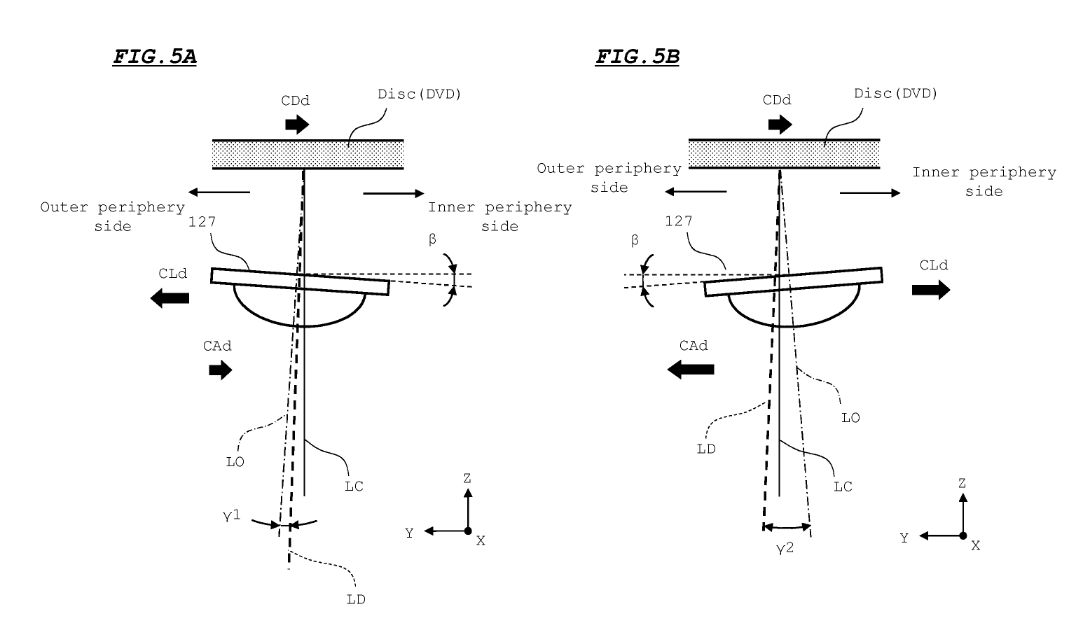

FIG. 5A is a diagram schematically showing how inherent coma aberration with respect to red laser light for DVD is suppressed by inclining the CD/DVD objective lens 127.

As described above, red laser light for DVD enters into the collimator lens 124 with an optical axis displacement. Therefore, the red laser light which has passed through the collimator lens 124 propagates in a direction approaching the optical axis of infrared laser light for CD. The optical axis of the red laser light after transmitted through the collimator lens 124 approaches the optical axis of the infrared laser light. As a result, as shown in FIG. 5A, the red laser light enters into the CD/DVD objective lens 127 in a state that the optical axis of the red laser light is inclined with respect to the optical axis LC of infrared laser light for CD.

As described above, since the CD/DVD objective lens 127 is inclined with the angle β in such a direction that the disc outer periphery side of the CD/DVD objective lens 127 is raised, the inclination angle γ1 of the optical axis/L0 of the CD/DVD objective lens 127 with respect to the optical axis LD of red laser light becomes relatively small. Accordingly, the correction coma aberration CAd generated in red laser light by inclining the CD/DVD objective lens 127 is small.

However, since red laser light enters into the disc (DVD) in an oblique direction, coma aberration (hereinafter, this coma aberration is called as “disc coma aberration”) is generated on a cover layer of the disc. The direction of the disc coma aberration CDd is opposite to the direction of the inherent coma aberration CLd with respect to red laser light, and is the same as the direction of the correction coma aberration CAd. Accordingly, as described above, even if the correction coma aberration CAd generated in red laser light is relatively small, it is possible to smoothly suppress the inherent coma aberration CLd in combination with the disc coma aberration CDd.

In this embodiment, the inherent coma aberrations CLb, CLc, and CLd are suppressed by inclining the BD objective lens 108 and the CD/DVD objective lens 127 in such a direction that the disc outer periphery sides of both of the BD objective lens 108 and the CD/DVD objective lens 127 are raised. Conversely, however, even if the BD objective lens 108 and the CD/DVD objective lens 127 are disposed at such positions that the inherent coma aberrations CLb and CLc are generated in a direction toward the disc inner periphery, it is possible to suppress the inherent coma aberrations CLb and CLc with respect to blue laser light and infrared laser light by disposing the BD objective lens 108 and the CD/DVD objective lens 127 at such positions that the BD objective lens 108 and the CD/DVD objective lens 127 are inclined with the angles α and β so that the disc inner periphery sides of the BD objective lens 108 and the CD/DVD objective lens 127 are raised. In the above case, the correction coma aberration CAb and CAc with respect to blue laser light and infrared laser light are generated in the directions opposite to the above to thereby cancel the inherent coma aberrations CLb and CLc.

Further, in the above case, as shown in FIG. 5B, the inclination angle γ2 of the optical axis L0 of the CD/DVD objective lens 127 with respect to the optical axis LD of red laser light becomes large. Accordingly, the correction coma aberration CAd with respect to red laser light also becomes large. However, in this case, since the direction of the disc coma aberration CDd with respect to red laser light is the same as the direction of the inherent coma aberration CLd with respect to red laser light, and is opposite to the direction of the correction coma aberration CAd. Accordingly, in this case, it is necessary to cancel both of the inherent coma aberration CLd and the disc coma aberration CDd by the correction coma aberration CAd. Thus, even if the correction coma aberration CAd generated in red laser light is relatively large as described above, it is possible to smoothly suppress both of the disc coma aberration CDd and the inherent coma aberration CLd.

As described above, even if the inclination directions of the BD objective lens 108 and the CD/DVD objective lens 127 are opposite to the directions shown in FIG. 5A, it is possible to smoothly suppress the inherent coma aberrations CLb, CLc, and CLd by setting the directions of the inherent coma aberrations CLb, CLc, and CLd opposite to the directions shown in FIG. 5A.

However, if the inclination direction of the CD/DVD objective lens 127 is set opposite to the direction shown in FIG. 5A as described above, as shown in FIG. 5B, the inclination angle γ2 of the optical axis L0 of the CD/DVD objective lens 127 with respect to the optical axis LD of red laser light becomes large. As a result, the magnitude of astigmatism generated in red laser light becomes considerably large, as compared with the case shown in FIG. 5A. This may deteriorate the beam characteristics of red laser light on a recording layer of DVD, and degrade the recording/reproducing characteristics.

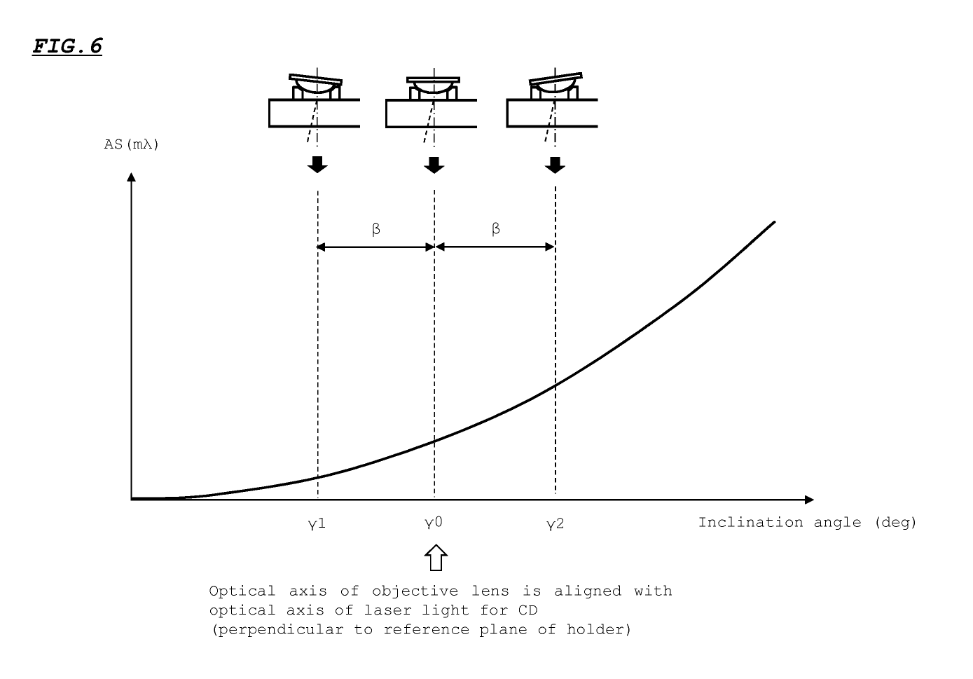

FIG. 6 is a diagram schematically showing a relation between inclination angle of the optical axis L0 of the CD/DVD objective lens 127 with respect to the optical axis LD of red laser light, and astigmatism generated in red laser light. In FIG. 6, the reference numeral γ0 denotes an inclination angle of the optical axis L0 of the CD/DVD objective lens 127 with respect to the optical axis LD of red laser light, in the case where the CD/DVD objective lens 127 is not inclined with respect to the reference plane S0 of the holder 131 (a state that the optical axis of the CD/DVD objective lens 127 is perpendicular to the reference plane S0 of the holder 131). The reference numerals γ1 and γ2 respectively correspond to γ1 and γ2 in FIGS. 5A and 5B.

As is obvious from the relational diagram of FIG. 6, it is desirable to incline the CD/DVD objective lens 127 in such a direction as to reduce the inclination angle of the optical axis L0 of the CD/DVD objective lens 127 with respect to the optical axis LD of red laser light. Therefore, as described in the embodiment shown in FIG. 5A, it is desirable to incline the CD/DVD objective lens 127 in such a direction that the disc outer periphery side of the CD/DVD objective lens 127 is raised, in place of inclining the CD/DVD objective lens 127 as shown in FIG. 5B.

As described above, in this embodiment, inherent coma aberrations inherent to the BD objective lens 108 and the CD/DVD objective lens 127 are suppressed by inclining the BD objective lens 108 and the CD/DVD objective lens 127. Further, since the direction of inclining the CD/DVD objective lens 127 is set in such a direction as to reduce the inclination angle of the optical axis L0 of the CD/DVD objective lens 127 with respect to the optical axis LD of red laser light, astigmatism generated in red laser light is suppressed.

As described above, in this embodiment, it is possible to smoothly suppress astigmatism of red laser light, as well as coma aberration, and to enhance the beam characteristics of laser light to be irradiated onto CD, DVD, and BD. Accordingly, it is possible to enhance the recording/reproducing characteristics for CD, DVD, and BD.

Further, in this embodiment, since the CD/DVD objective lens 127 is inclined in such a direction that the optical axis of red laser light transmitted through the collimator lens 124 approaches the optical axis LC of infrared laser light, it is possible to efficiently reduce the inclination angle of the optical axis L0 of the CD/DVD objective lens 127 with respect to the optical axis LD of red laser light, and effectively suppress astigmatism generated in red laser light.

Furthermore, in this embodiment, since the direction of inclining the BD objective lens 108 and the direction of inclining the CD/DVD objective lens 127 are aligned with the disc radial direction, it is possible to uniquely determine the directions of inherent coma aberrations and the directions of inclining each of the objective lenses in mounting each of the objective lenses on the holder 131, thereby enhancing the operability in mounting the objective lenses.

The embodiment of the invention has been described as above. The invention is not limited to the foregoing embodiment, and the embodiment of the invention may be modified in various ways other than the above.

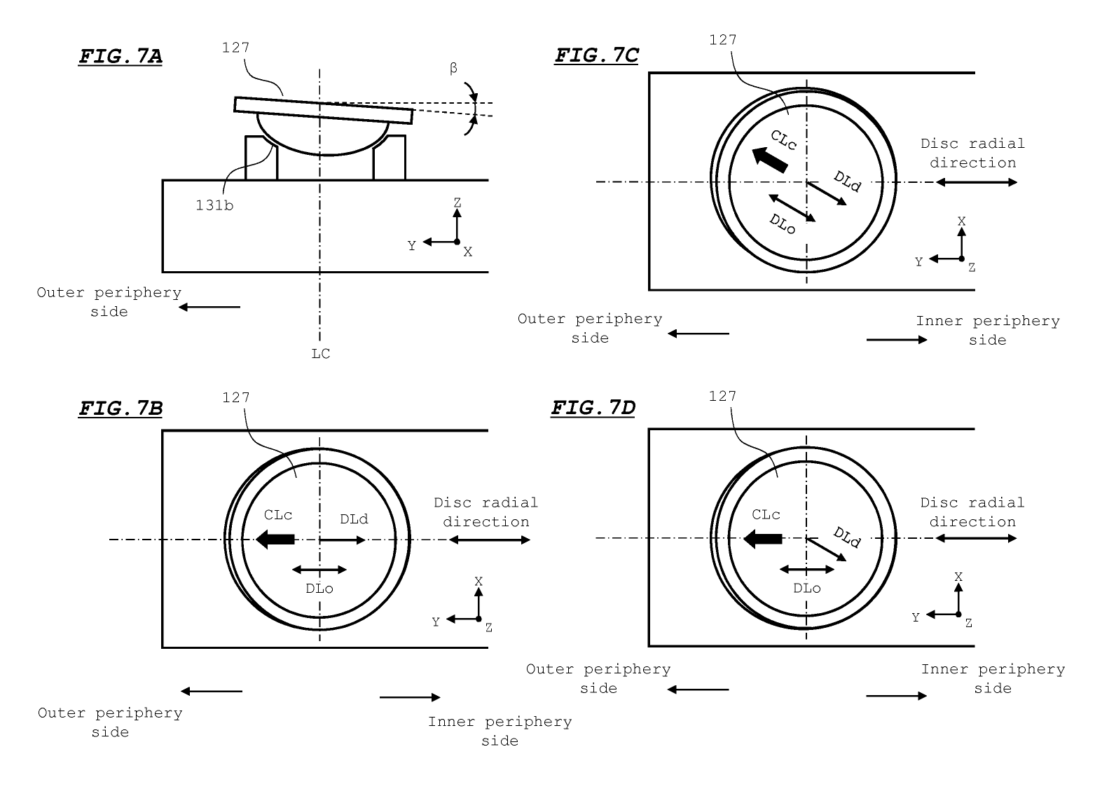

For instance, in the embodiment, as shown in FIG. 7B, the inclination direction DL (direction in which the optical axis LD approaches the optical axis LC) of the optical axis LD of red laser light with respect to the optical axis LC of infrared laser light is aligned with the disc radial direction. Accordingly, astigmatism generated in red laser light is efficiently suppressed by inclining the inclination direction DLo of the CD/DVD objective lens 127 toward the disc radial direction.

Alternatively, in the case where the inclination direction DLd of the optical axis of red laser light is different from the disc radial direction, as shown in FIG. 7C, it is possible to efficiently reduce the inclination angle γ of the optical axis L0 of the CD/DVD objective lens 127 with respect to the optical axis LD of red laser light, and to effectively suppress astigmatism generated in red laser light, in the similar manner as the embodiment, by aligning the direction of the inherent coma aberration CLc and the inclination direction DLo of the CD/DVD objective lens 127 in a direction in parallel to the inclination direction DLd.

In the case where the inclination direction DLd of the optical axis LD of red laser light is different from the disc radial direction, as shown in FIG. 7D, it is possible to reduce the inclination angle γ of the optical axis L0 of the CD/DVD objective lens 127 with respect to the optical axis LD of red laser light, and to effectively suppress astigmatism generated in red laser light, in the similar manner as the embodiment, by inclining the CD/DVD objective lens 127 in such a direction that the direction of the inherent coma aberration CLc and the inclination direction DLo of the CD/DVD objective lens 127 are aligned with the disc radial direction. In the latter case, however, as compared with the case shown in FIGS. 7B and 7C, since the reduction amount of the inclination angle γ by inclining the CD/DVD objective lens 127 by the angle β is small, the degree of suppressing astigmatism is small, as compared with the cases shown in FIGS. 7B and 7C.

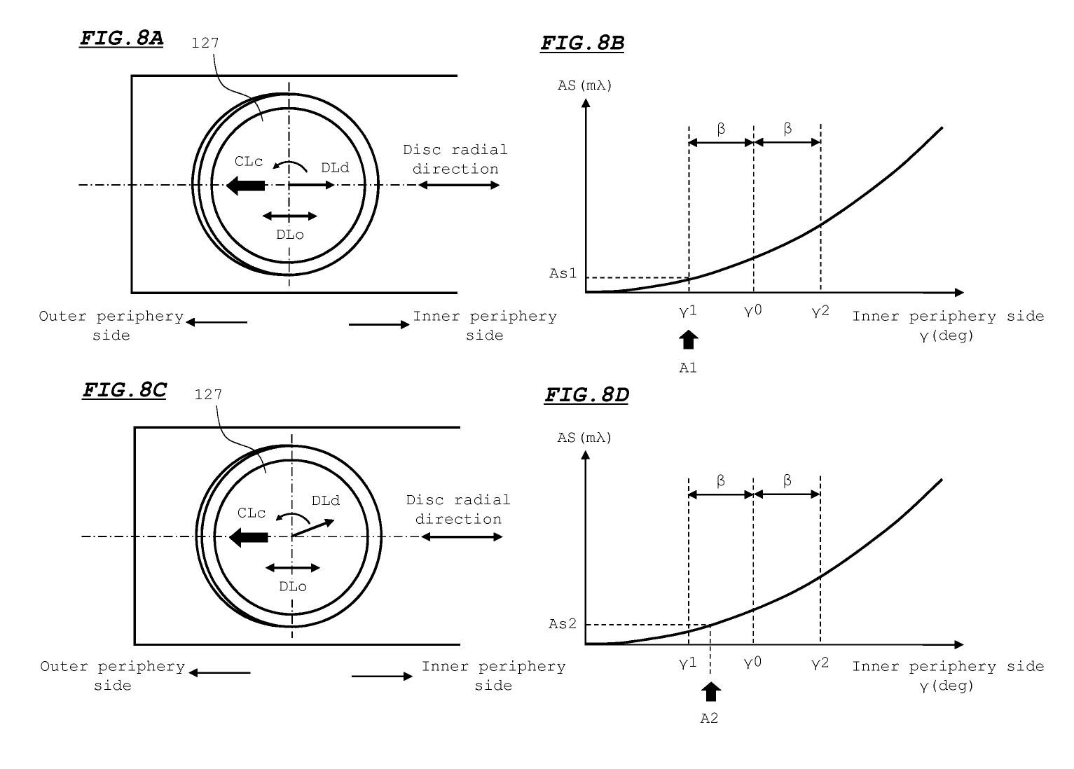

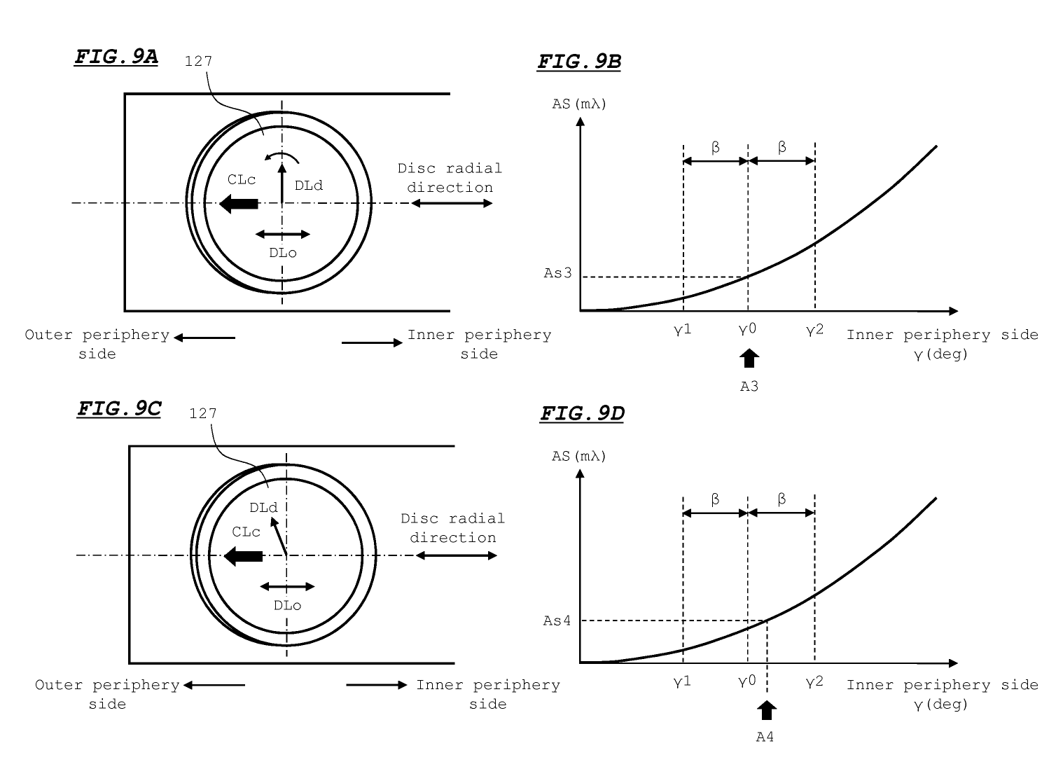

FIGS. 8A through 8D, and 9A through 9D are diagrams schematically showing a relation between the inclination direction DLd of the optical axis LD of red laser light with respect to the optical axis LC of infrared laser light, and astigmatism generated in red laser light.

FIG. 8A is a diagram showing a state that the inclination direction DLd of the optical axis LD of red laser light and the inclination direction DLo of the CD/DVD objective lens 127 are set as described in the embodiment. In this case, as described in the embodiment, if the CD/DVD objective lens 127 is inclined in the disc radial direction (inclination direction DLo) by the angle β from a state in parallel to the reference plane, as shown in FIG. 8B, the inclination angle γ of the optical axis L0 of the CD/DVD objective lens 127 with respect to the optical axis LD of red laser light becomes the inclination angle (γ1) shown by the symbol A1 in FIG. 8B. Thus, astigmatism generated in red laser light is maximally suppressed.

FIG. 8C is a diagram showing a state that the inclination direction DLd of the optical axis LD of red laser light and the inclination direction DLo of the CD/DVD objective lens 127 are displaced from each other. In this case, as described in the embodiment, if the CD/DVD objective lens 127 is inclined in the disc radial direction (inclination direction DLo) by the angle β from a state in parallel to the reference plane, as shown in FIG. 8D, the inclination angle γ of the optical axis L0 of the CD/DVD objective lens 127 with respect to the optical axis LD of red laser light becomes the angle at the broken-line position shown by the arrow A2 in FIG. 8D, and astigmatism generated in red laser light becomes AS2. The astigmatism AS2 generated in this case is larger than those shown in FIGS. 8A and 8B, but is improved, as compared with a case where the CD/DVD objective lens 127 is aligned in parallel to the reference plane (where γ=γ0).

FIG. 9A is a diagram showing a state that the inclination direction DLd of the optical axis LD of red laser light and the inclination direction DLo of the CD/DVD objective lens 127 are displaced from each other by 90 degrees. In this case, even if the CD/DVD objective lens 127 is inclined in the disc radial direction (inclination direction DLo) by the angle β from a state in parallel to the reference plane as described in the embodiment, as shown in FIG. 9B, the inclination angle of the optical axis L0 of the CD/DVD objective lens 127 with respect to the optical axis LD of red laser light becomes the angle (γ0) at the broken-line position shown by the arrow A3 in FIG. 9B, which is the same as before inclination, and astigmatism generated in red laser light becomes AS3. The astigmatism AS3 generated in this case is larger than those shown in FIGS. 8A through 8D, and is not improved, as compared with the case that the CD/DVD objective lens 127 is aligned in parallel to the reference plane.

FIG. 9C is a diagram showing a state that the inclination direction DLd of the optical axis LD of red laser light and the inclination direction DLo of the CD/DVD objective lens 127 are greatly displaced from each other by an angle larger than 90 degrees. In this case, if the CD/DVD objective lens 127 is inclined in the disc radial direction (inclination direction DLo) by the angle β from a state in parallel to the reference plane as described in the embodiment, as shown in FIG. 9D, the inclination angle γ of the optical axis L0 of the CD/DVD objective lens 127 with respect to the optical axis LD of red laser light becomes the angle at the broken-line position shown by the arrow A4 in FIG. 9D, and astigmatism generated in red laser light becomes AS4. The astigmatism AS4 generated in this case is further larger than those shown in FIGS. 9A and 9B, and is deteriorated, as compared with the case where the CD/DVD objective lens 127 is aligned in parallel to the reference plane.

In all the cases shown in FIGS. 8A through 8D, and FIGS. 9A through 9D, the inherent coma aberrations CLc and CLd of the CD/DVD objective lens 127 with respect to infrared laser light and red laser light are suppressed by inclining the CD/DVD objective lens 127 by the angle β.

As is obvious from FIGS. 8A through 8D, and FIGS. 9A through 9D, in order to improve astigmatism as well as coma aberration, it is necessary to set a displacement between the inclination direction DLd of the optical axis LD of red laser light and the inclination direction DLo of the CD/DVD objective lens 127 to an angle smaller than 90 degrees. Most preferably, as described in the embodiment, the inclination direction DLd of the optical axis LD of red laser light is aligned in parallel to the inclination direction DLo of the CD/DVD objective lens 127. In view of this, it is desirable to set the layout of the CD/DVD optical system such that the inclination direction DLd of the optical axis LD of red laser light and the inclination direction DLo of the CD/DVD objective lens 127 approach a state parallel to each other in a range where the displacement between the inclination direction DLd and the inclination direction DLo is set to an angle smaller than 90 degrees.

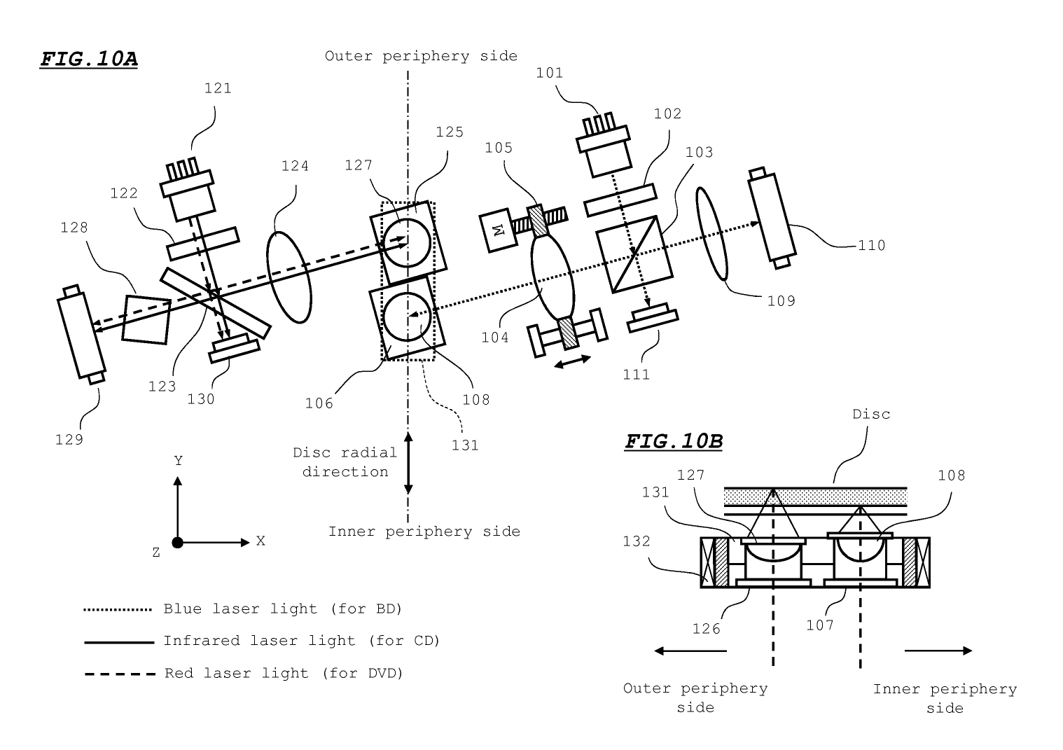

FIGS. 10A and 10B show an arrangement example, in the case where the layout of the optical system of the optical pickup device is modified from the arrangement shown FIGS. 1A and 1B. In the arrangement example shown in FIGS. 10A and 10B, as compared with the arrangement example shown in FIGS. 1A and 1B, the layout is modified so that the BD optical system and the CD/DVD optical system are rotated in counterclockwise direction by a predetermined angle. The holder 131 is disposed in the same manner as shown in FIGS. 1A and 1B, and the BD objective lens 108 and the CD/DVD objective lens 127 are disposed to be aligned in the disc radial direction (Y-axis direction) in the same manner as described above.

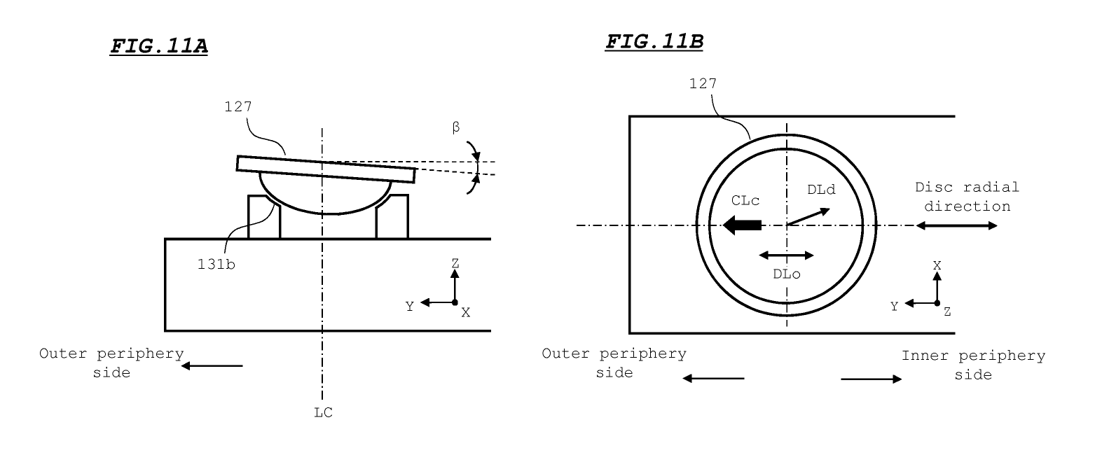

Referring to FIGS. 11A and 11B, in the above modification example, the inclination direction DLo of the CD/DVD objective lens 127 is set in the disc radial direction in the same manner as described in the embodiment. Similarly to the embodiment, the CD/DVD objective lens 127 is inclined in the disc radial direction by the angle β. Further, the inclination direction DLd of the optical axis LD of red laser light with respect to the optical axis LC of infrared laser light is displaced in counterclockwise direction from the direction in parallel to the disc radial direction. Here, the displacement between the inclination direction DLd of the optical axis LD of red laser light and the inclination direction DLo of the CD/DVD objective lens 127 is about 30 degrees. Similarly to the embodiment, the BD objective lens 108 is inclined in the disc radial direction by the angle α.

In the above modification, inherent coma aberrations of the CD/DVD objective lens 127 and the BD objective lens 108 are also suppressed by inclining the CD/DVD objective lens 127 and the BD objective lens 108 in the same manner as described in the embodiment. Further, since the displacement between the inclination direction DLd of the optical axis LD of red laser light and the inclination direction DLo of the CD/DVD objective lens 127 is smaller than 90 degrees, as described referring to FIGS. 8A through 8D, and 9A through 9D, astigmatism generated in red laser light is suppressed.

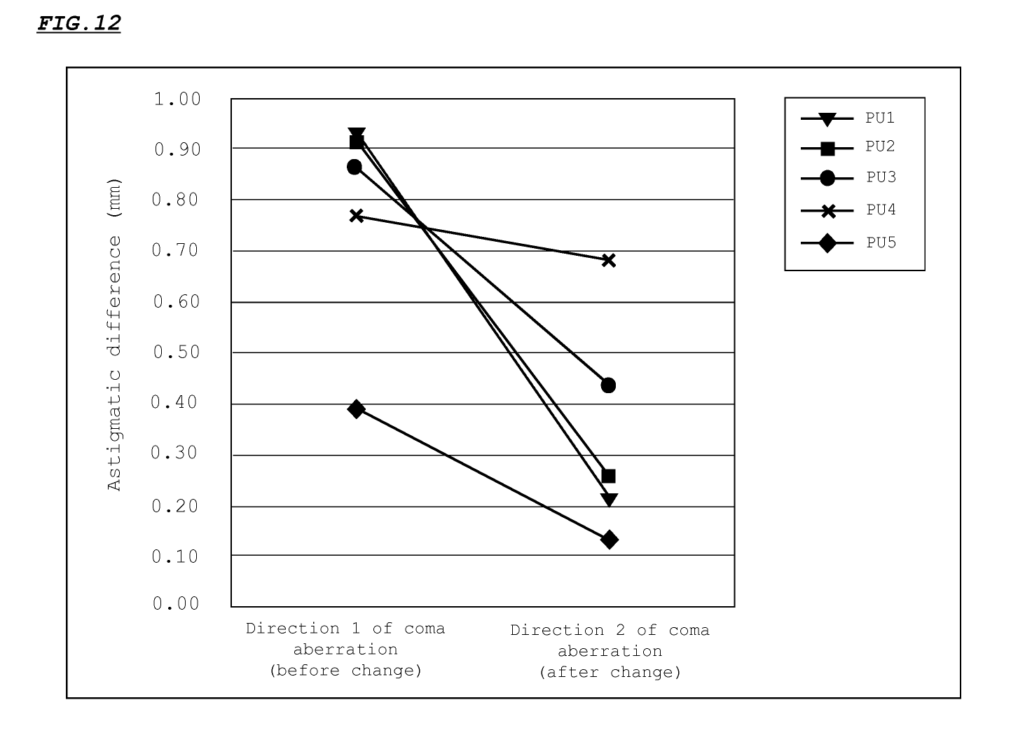

FIG. 12 shows measurement results obtained by measuring astigmatism generated in red laser light, in the case where the CD/DVD objective lens 127 is inclined by the angle β as described above to suppress inherent coma aberration in the optical pickup device having the optical system shown in FIGS. 11A and 11B. Here, measurement was performed by using five different optical pickup devices. In the optical pickup devices used in the measurement, the displacement between the inclination direction DLd of the optical axis LD of red laser light with respect to the optical axis LC of infrared laser light, and the inclination direction DLo of the CD/DVD objective lens 127 was 30 degrees. The inclination direction DLd of the optical axis LD of red laser light with respect to the optical axis LC of infrared laser light can be adjusted by rotating the semiconductor laser 121 around the optical axis of the laser element 121b in FIG. 2B.

An astigmatic difference along the vertical axis in FIG. 12 is a distance between two focal lines when red laser light is converged on the CD/DVD objective lens 127. The astigmatic difference was measured for a main beam by a spot measuring device. Further, the right-side plots in FIG. 12 indicate measurement results of each of the optical pickup devices when the CD/DVD objective lens 127 were inclined in the disc radial direction by the angle β as described in the embodiment, and the left-side plots in FIG. 12 indicate measurement results (comparative examples) of each of the optical pickup devices when the CD/DVD objective lens 127 was inclined in the direction opposite to the direction in the embodiment by the angle β.

As shown in FIG. 12, in the embodiment, the astigmatic difference is remarkably improved, as compared with the comparative examples.

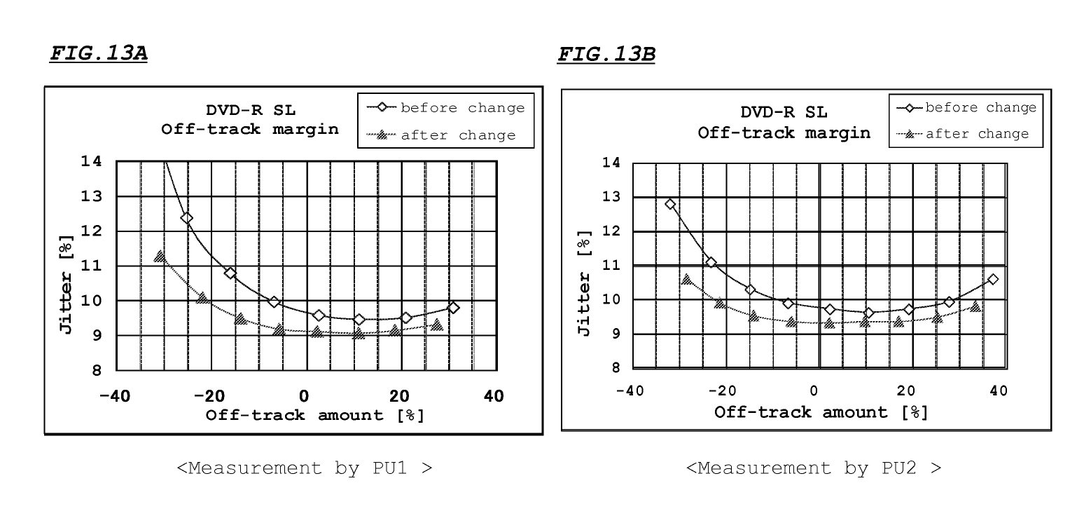

FIGS. 13A and 13B show measurement results obtained by measuring jitter in the two optical pickup devices (PU1, PU2) used in the measurement shown in FIG. 12. In the measurement, the jitter amount was measured by irradiating a beam spot of red laser light off the track on DVD in the disc radial direction. In FIGS. 13A and 13B, the horizontal axis denotes off-track amount, and the vertical axis denotes jitter amount. In FIGS. 13A and 13B, the indication “BEFORE CHANGE” shows the measurement results of the comparative examples in FIG. 12, and the indication “AFTER CHANGE” shows the measurement results of the arrangement of the embodiment in FIG. 12.

As shown in FIGS. 13A and 13B, in the comparative examples, a large amount of jitter is generated, and the position where jitter has a minimum value (bottom) is displaced from the position where the off-track amount is zero. In contrast, in the embodiment, as compared with the comparative examples, jitter is remarkably improved, and the bottom position is substantially coincident with the position where the off-track amount is zero. This is conceivably because astigmatism generated in red laser light is suppressed, and the beam characteristics are improved.

As is obvious from the measurement results shown in FIGS. 12, 13A, and 13B, even if the optical pickup device is configured such that the inclination direction DLd of the optical axis LD of red laser light with respect to the optical axis LC of infrared laser light, and the inclination direction DLo of the CD/DVD objective lens 127 are displaced from each other as shown in the modification example in FIGS. 11A and 11B, it is possible to effectively suppress astigmatism generated in red laser light as well as coma aberration. Further, these measurement results show that more satisfactory beam characteristics are obtainable by aligning the inclination direction DLd of the optical axis LD of red laser light with respect to the optical axis LC of infrared laser light and the inclination direction DLo of the CD/DVD objective lens 127 in parallel with each other as shown in the arrangement of FIGS. 1A and 1B.

In the embodiment, an optical pickup device using two objective lenses has been described. The optical system of the optical pickup device is not limited to the above, but an optical pickup device using only one objective lens may be applied to the invention. In the above case, however, three kinds of laser light having wavelengths different from each other enters into the one objective lens. In the case where an optical pickup device for the CD/DVD optical system has only one objective lens, similarly to the embodiment, three kinds of laser light having wavelengths different from each other enters into the one objective lens. In this case, the BD optical system including the BD objective lens 108 is omitted from the arrangement of the embodiment.

Further, in the embodiment, the BD objective lens 108 is disposed on the disc inner periphery side, and the CD/DVD objective lens 127 is disposed on the disc outer periphery side. Alternatively, the BD objective lens 108 may be disposed on the disc outer periphery side, and the CD/DVD objective lens 127 may be disposed on the disc inner periphery side.

Further alternatively, the semiconductor laser 121 may be disposed, for instance, at such a position that the laser element 121a for emitting red laser light is rotated around the optical axis of infrared laser light by 180 degrees in FIG. 2B. In the modification, for instance, the optical axis of red laser light is inclined in the direction opposite to the direction shown in FIGS. 5A and 5B with respect to the optical axis of infrared laser light. In this case, the CD/DVD objective lens 127 may be inclined in the direction opposite to the direction shown in the embodiment, in other words, in the direction shown in FIG. 5B.

In the embodiment, a cubic polarized beam splitter 103 is illustrated and used as a beam splitter of the BD optical system. Alternatively, similarly to the CD/DVD optical system, a transparent parallel flat plate may be disposed to be inclined with respect to the optical axis of laser light. In the modification, similarly to the CD/DVD optical system, a correcting plate may be disposed in place of the anamorphic lens 109.

In the embodiment, a 3-beam optical pickup device is illustrated and used. The invention may be applied to a 1-beam optical pickup device.

In addition to the above, the invention may be applied to an optical pickup device other than the optical pickup device compatible with BD/DVD/CD, and may also be applied to an optical pickup device for HD-DVD, as necessary.

The embodiment of the invention may be changed or modified in various ways as necessary, as far as such changes and modifications do not depart from the scope of the claims of the invention hereinafter defined.

What is claimed is:

1. An optical pickup device, comprising:
a first laser light source including a first laser element which emits first laser light and a second laser element which emits second laser light of a wavelength different from a wavelength of the first laser light, the first laser element and the second laser element being housed in a CAN with emission directions thereof being the same as each other;
a collimator lens into which the first laser light and the second laser light enter;
a first objective lens into which the first laser light and the second laser light transmitted through the collimator lens enter;
a holder which holds the first objective lens thereon; and
an actuator which drives the holder at least in a focus direction and in a tracking direction, wherein
the collimator lens and the first objective lens are disposed at such positions that optical axes thereof are aligned with an optical axis of the first laser light, and
the first objective lens is mounted on the holder to be inclined in such a direction as to suppress coma aberration of the first objective lens and to suppress astigmatism generated in the second laser light from a state in parallel to a reference plane of the holder.

2. The optical pickup device according to claim 1, wherein
the first objective lens is mounted on the holder to be inclined in such a direction as to reduce an angle between an optical axis of the second laser light and the optical axis of the first objective lens.

3. The optical pickup device according to claim 1, wherein
the first objective lens is mounted on the holder to make a direction of coma aberration of the first objective lens opposite to a direction of coma aberration resulting from inclination of the first objective lens.

4. The optical pickup device according to claim 1, wherein
the first objective lens is inclined in such a direction that an optical axis of the second laser light after transmitted through the collimator lens approaches an optical axis of the first laser light.

5. The optical pickup device according to claim 1, further comprising:
a second laser light source which emits third laser light of a wavelength different from both of the wavelength of the first laser light and the wavelength of the second laser light, and
a second objective lens into which the third laser light from the second laser light source enters, wherein
the second objective lens is mounted on the holder to be inclined in such a direction as to suppress coma aberration of the second objective lens from the state in parallel to the reference plane of the holder.

6. The optical pickup device according to claim 5, wherein
the first objective lens and the second objective lens are mounted on the holder to be inclined in the same direction as each other.
